(19) United States
(12) Patent Application Publication
(10) Pub. No.: US 2024/0366339 A1
(43) Pub. Date: Nov. 7, 2024

(54) INTERPROXIMAL REDUCTION TOOL WITH TAPERED THICKNESS

(71) Applicant: Brian WILK, Chalfont, PA (US)

(72) Inventor: Brian WILK, Chalfont, PA (US)

(21) Appl. No.: 18/654,692

(22) Filed: May 3, 2024

Related U.S. Application Data
(60) Provisional application No. 63/499,898, filed on May 3, 2023.

(51) Int. Cl. A61C 5/88

(52) U.S. Cl. CPC A61C 5/88; A61C 2201/00

(57) ABSTRACT

A tapered-thickness single strip interproximal reduction tool having a thickness that progressively decreases in width from one end to the other along its length so that it is easier to pull through the contact areas intended to open up a space, and does not need to be removed to change thicknesses. In a typical embodiment the narrowest end of the strip would be 0.1 mm and gradually thickens from the narrow end to the thickest end.

### CROSS-REFERENCE TO RELATED APPLICATIONS

This application claims priority to U.S. Provisional Application No. 63/499,898, filed on May 3, 2023, the entire contents of which being fully incorporated herein by reference.

### FIELD OF THE INVENTION

The present invention relates generally to dentistry and more specifically to an interproximal reduction tool and method, which enables a space to be created between adjacent teeth that are in contact with each other.

Interproximal reduction is a procedure used in Orthodontics to create a space between two adjacent teeth to allow for Orthodontic Movement between the two adjacent teeth. Creation of a space between two adjacent teeth has traditionally been done with burs, regular discs or finishing strips. Each of these methods creates various problems. Further, space created between two adjacent teeth needs to be estimated by eye or by using a separate metal gauge known as the Womack Gauge. (https://orthopracticeus.com/the-master-s-guide-to-interproximal-reduction-ipr/).

In many cases, the strips are held by a tool to make it easier for them to be manipulated between the teeth. Examples of such configurations can be found in U.S. Pat. No. 10,117,725 to Khouri, U.S. Pat. No. 7,455,521 to Fishbourne, Jr., and U.S. Design Patent D779,672 to Tapocik. In each instance, the strips are of uniform thickness, requiring the use of several different strips and/or tools to gradually create the space. The use of multiple tools, and the need to repeatedly use a measuring device to measure progress, is time consuming and costly.

Accordingly, there is a long-felt need in the art for an interproximal reduction tool and method, which greatly reduces the number of tools (disks, strips, diamond burs, and the like) needed and simplifies the process of using them. Each Interproximal device currently on the market or in the prior art is a single thickness instrument. Thus, to open up a space to 0.5 mm using prior art systems and methods, one first uses a tool of a first thickness to go to 0.1 mm opening, a second tool of a wider thickness to go to 0.2 mm opening, a third tool of still a wider thickness to get a 3 mm opening and so on. Orthodontists and dentists typically do not open up the Interproximal areas greater than 5 mm.

An inherent drawback with these prior art methods is the difficulty in generating sufficient leverage on the tool when in use to effectively remove unwanted material.

### SUMMARY OF THE INVENTION

The present invention comprises a tapered-thickness single strip tool having a thickness that progressively decreases in width from one end to the other along its length so that it is easier to pull through the contact areas intended to open up a space, and does not need to be removed to change thicknesses. In a typical embodiment the narrowest end of the strip would be 0.1 mm and gradually thickens from the narrow end to the thickest end.

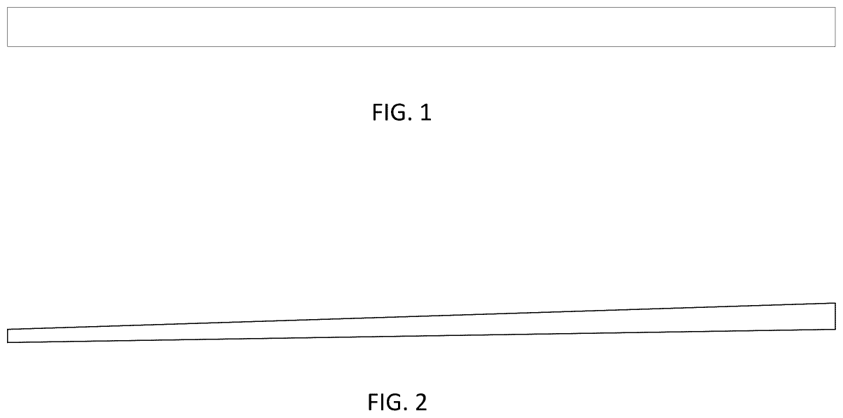

FIGS. 1 and 2 are top and side views, respectively, of a tapered-thickness single strip interproximal tool as contemplated by the present invention. As can best be seen in the side view of FIG. 2 (which is not to scale and is exaggerated for ease of explanation), the strip is thicker at the right end and tapers to a narrower thickness at the left end. Although not shown in the figures, if desired, the thicknesses at points along the length of the strip can be marked on the strip so that a user can see the thickness that is between the teeth at any given time, reducing or eliminating the need to stop and take measurement during the process. Also, by starting with the narrow end between the teeth, the user can move the strip towards the thicker end of the strip to go from narrower to thicker portions between the teeth and can get a “running start” as the strip is moved between the teeth. This simplifies the creation of space between teeth because, among other things, it does not require the user to switch to different sized strips as the space widens.

The interproximal dental tool of the present invention is effective at removing unwanted material, easier to use, and less likely to result in injury to the patient or dental practitioner during use.

All other interproximal devices in dentistry are currently single thickness. This is the first multi-thickness interproximal device. It can be constructed in essentially the same manner (i.e., same material, same construction process, etc.) as the prior art single-thickness strips except that the strip is constructed with gradually-increasing thicknesses from one end to the other. It can be utilized by placement in a tool such as those shown in the prior art cited above, and they can be made easily removeable from the tools so that they can be easily replaced as needed.

The device itself can be constructed using flexible metal (e.g., stainless steel) strips, fabricated to have a larger thickness (e.g., 0.6 mm) at one end and gradually tapering to a smaller thickness (e.g., 0.05 mm) at the other end, and coated with a diamond “sandpaper-like” material, constructed in any known manner. Abrasive Technology in Lewis Center, Ohio is one company that manufactures diamond finish strips that include diamond material bonded to metal and this is an example of one manner of providing the strips with diamond coating. The materials can, of course differ, but the inventive element is that the tool, regardless of configuration or type of material used for the coating or the flexible strips, is thicker at a first end and gradually tapers to be a smaller thickness at a second end. A typical taper would go from 0.5 mm at the thickest point to 0.1 mm at the thinnest, but there is no reason, other than practicality, that the largest width couldn't be larger or the narrowest width could be smaller. In terms of length, the strips can vary in length depending on the manner in which they are being used; handheld strips would typically be 1-6 inches long, while those held by a tool would be sized to fit the tool, in which case they could be shorter than one inch in certain applications, and longer than 6 inches in others.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

1. A tapered-thickness single strip interproximal tool having a thickness that progressively decreases in thickness from a first end to a second end.

2. The tapered-thickness single strip interproximal tool according to claim 1, wherein the first end is approximately 0.5 mm thick.

3. The tapered-thickness single strip interproximal tool according to claim 2, wherein the second end is approximately at least approximately 0.05 mm thick.

4. The tapered-thickness single strip interproximal tool according to claim 3, wherein the tapered-thickness single strip proximal tool has a length in a range from approximately 1 inch to approximately 6 inches.

5. The tapered-thickness single strip interproximal tool according to claim 4, wherein the tapered-thickness single strip proximal tool comprises a strip of flexible metal.

6. The tapered-thickness single strip interproximal tool according to claim 5, wherein the flexible metal comprises stainless steel.

7. The tapered-thickness single strip interproximal tool according to claim 5, wherein the strip of flexible metal is coated with a diamond-coat, sandpaper-like material.

8. A method of fabricating an interproximal tool comprising the steps of:
fabricating a single strip of flexible material having first end of a first thickness and second end of a second thickness, with the first thickness being larger than the second thickness; and
coating the strip of flexible material with a diamond-coat, sandpaper-like material;
wherein an overall thickness of the single strip of flexible material progressively decreases in thickness from the first end to the second end.
